(19) United States
(12) Patent Application Publication
(10) Pub. No.: US 2011/0165497 A1
(43) Pub. Date: Jul. 7, 2011

(54) Method for Mitigating Fuel Cell Chemical Degradation

(75) Inventors: Sean M. MacKinnon, Fairport, NY (US); Timothy J. Fuller, Pittsford, NY (US)

(73) Assignee: GM GLOBAL TECHNOLOGY OPERATIONS, INC., DETROIT, MI (US)

(21) Appl. No.: 12/683,120

(22) Filed: Jan. 6, 2010

(51) Int. Cl. H01M 8/10

(52) U.S. Cl. 429/492; 427/115; 429/494

(57) ABSTRACT

A composite membrane for fuel cell applications includes a support substrate with a predefined void volume. The void volume is at least partially filled with an ion conducting polymer composition that includes an additive that inhibits polymer degradation. Characteristically, the ion conducting polymer composition includes a first polymer with a cyclobutyl moiety and a second polymer that is different than the first polymer.

### BACKGROUND OF THE INVENTION

1. Field of the Invention

The present invention relates to ion conductive polymers, fuel cell membranes and membrane electrode assemblies.

2. Background Art

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ion conductive polymer membrane to the cathode where they combine with oxygen to form water which is discharged from the cell. Typically, the ion conductive polymer membrane includes a perfluorinated sulfonic acid (PFSA) ionomer.

The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

One mechanism by which ion conducting polymer membranes degrade is via loss of fluorine (i.e., fluoride emission) under open circuit voltage (OCV) and dry operating conditions at elevated temperatures. Additives to PFSA membranes are required to improve fuel cell life, increase membrane durability and reduce fluoride emissions under these conditions.

Accordingly, there is a need for improved ion conducting membranes with reduced fluoride emissions.

### SUMMARY OF THE INVENTION

The present invention solves one or more problems of the prior art by providing in at least one embodiment a composite ion-conducting membrane for fuel cell applications with improved resistance to chemical degradation. The composite membrane of the present embodiment includes a support structure having a predetermined void volume. A polymeric electrolyte composition contacts the support structure. The polymeric electrolyte composition includes a first polymer having a perfluorocyclobutyl moiety and an additive that inhibits polymeric degradation.

In another embodiment of the present invention, a method of forming the composite membrane set forth above is provided. The method of this embodiment comprises a step in which a support structure is contacted with a first polymer-containing solution which includes an additive that inhibits polymeric degradation and/or porphyrin-containing compound. The support structure is formed from a polymer and has a predetermined porosity such that the first polymer-containing solution penetrates into interior regions of the support structure defined by the predetermined porosity. The first polymer-containing solution coats at least a portion of the interior regions to form a first coated support structure. The first coated support structure is coated with a second polymer-containing solution that penetrates into interior regions of the first polymer-coated support structure to form a second coated support structure. Penetration of the second polymer-containing solution is enhanced by the first polymer-containing solution as compared to a support structure that is not coated by the first polymer-containing solution. Finally, solvent is removed from the second coated support structure to form the composite membrane.

In another embodiment of the present invention, a method of forming the composite membrane set forth above is provided. The method of this embodiment comprises a step in which a support structure is contacted with a first polymer-containing solution which includes an additive that inhibits polymeric degradation. The support structure is formed from a polymer and has a predetermined porosity such that the first polymer-containing solution penetrates into interior regions of the support structure defined by the predetermined porosity. Typically, the first polymer of the first polymer-containing composition includes a perfluorocyclobutyl moiety. The first polymer-containing solution coats at least a portion of the interior regions to form a coated support structure. Finally, solvent is removed from the coated support structure to form the composite membrane.

It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating the polymers of an embodiment of the present invention; and

FIG. 2 is a cross-section of a portion of an embodiment of a composite membrane.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The following description of the embodiment(s) is merely exemplary in nature and is in no way intended to limit the invention, its application, or uses.

The term “block” as used herein means a portion of a macromolecule, comprising many constitutional units, that has at least one feature that is not present in adjacent portions.

The term “block macromolecule” as used herein means a macromolecule that is composed of blocks in linear sequence.

The term “block polymer” as used herein means a substance composed of block macromolecules.

The term “block copolymer” as used herein means a polymer in which adjacent blocks are constitutionally different, i.e., each of these blocks comprises constitutional units derived from different characteristic species of monomer or with different composition or sequence distribution of constitutional units.

The term “random copolymer” as used herein means a copolymer consisting of macromolecules in which the probability of finding a given repeating unit at any given site in the chain is independent of the nature of the adjacent units.

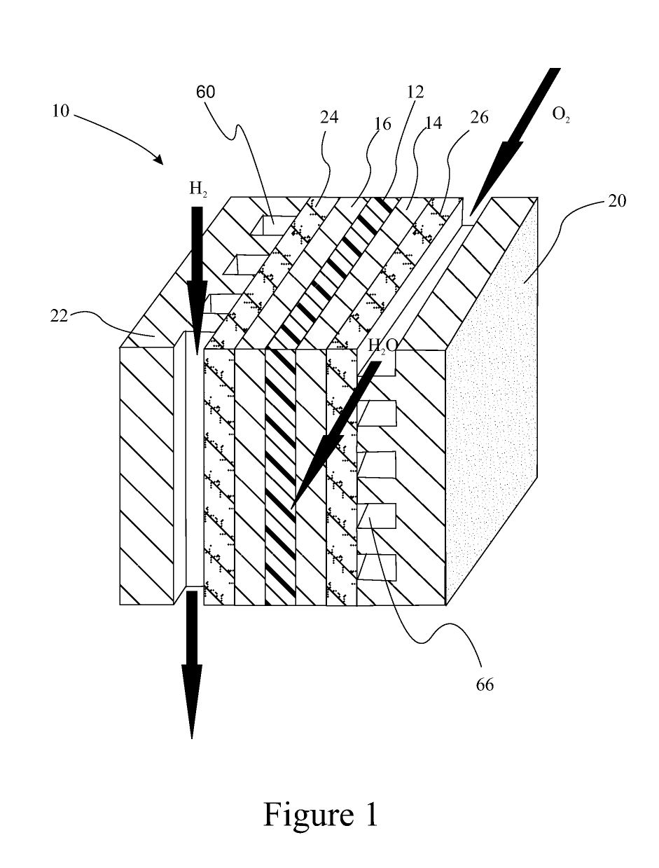

With reference to FIG. 1, a fuel cell that incorporates a polymer electrolyte including polymers from the invention is provided. PEM fuel cell 10 includes polymeric ion conductive membrane 12 disposed between cathode catalyst layer 14 and anode catalyst layer 16. Polymeric ion conductive composite membrane 12 includes one or more of the polymers set forth below. Fuel cell 10 also includes conductive plates 20, 22, gas channels 60 and 66, and gas diffusion layers 24 and 26. Advantageously, the present invention provides embodiments for composite membrane 12.

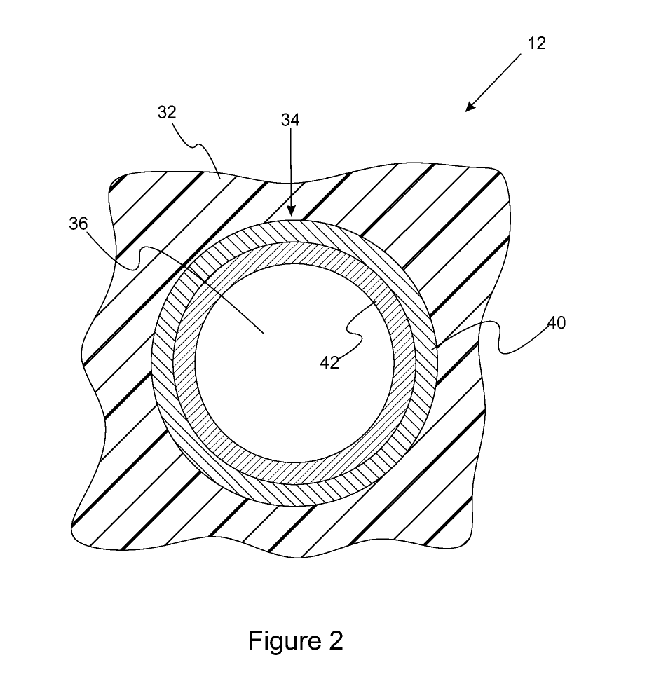

In an embodiment of the present invention, a composite membrane for use in an electrochemical cell is provided. FIG. 2 provides a cross-section of a portion of the composite membrane with a single void depicted therein. Composite membrane 12 includes support structure 32 having a predetermined void volume. Typically, the void volume is from 30 volume percent to 95 volume percent of the total volume of support structure 32. Support structure 32 may be formed from virtually any polymeric material having the requisite void volume. Expanded polytetrafluoroethylene is particularly useful for this application. Polymeric electrolyte composition 34 contacts support structure 32. Polymeric electrolyte composition 34 includes a first polymer which is ionic and the residues of an additive that inhibits polymeric degradation. Suitable ionic polymers include PFSA polymers and polymers having a perfluorocyclobutyl moiety. In a refinement, polymeric electrolyte composition 34 also includes a second polymer that is different than the first polymer. In a refinement, at least 50 percent of the void volume includes polymeric electrolyte composition 34, i.e., is filled with the polymeric electrolyte composition.

Still referring to FIG. 2, composite membrane 12 is formed by contacting support structure 32 with a first polymer-containing solution which includes a first polymer and an additive that inhibits polymeric degradation. In a variation of the present embodiment, the first polymer-containing solution contains a sulfonated-perfluorocyclobutane polymer (i.e., ionomer) and a suitable solvent. In another variation, the first polymer-containing solution contains a PFSA polymer and a solvent. Examples of such solvents include alcohols, water, etc. In a refinement, the first polymer-containing solution comprises an ionomer in an amount from about 0.1 weight percent to about 5 weight percent of the total weight of the first polymer-containing solution. In another refinement, the first polymer-containing solution comprises an ionomer in an amount from about 0.5 weight percent to about 2 weight percent of the total weight of the first polymer-containing solution. The first polymer-containing solution penetrates into interior regions of support structure 32 such as void 36. At least a portion of the interior regions are coated with the first polymer-containing solution to form the first coated support structure. The first coated support structure is subsequently coated with a second polymer-containing solution that penetrates into interior regions of the coated support structure to form a second coated support structure. Penetration of the second polymer-containing solution is enhanced by the first polymer-containing solution as compared to a support structure or support membrane that is not coated by the first polymer-containing solution. Solvent(s) are then removed from the ionomer coated support membrane to form composite membrane 12. Therefore, composite membrane 12 includes first layer 40, which contacts at least a portion of support structure 32 and is disposed over a portion of the void volume such as void 36. First layer 40 comprises residues of the first polymer-containing solution. Composite membrane 12 also includes second layer 42 contacting at least a portion of the first layer. Second layer 42 comprises residues of a second polymer-containing solution.

As set forth above, the composite membrane includes an additive that inhibits polymeric degradation. In one variation, the additive that inhibits polymeric degradation is selected from the group consisting of cerium-containing compounds, manganese-containing compounds, and a porphyrin-containing compound. In another variation, the additive is a soluble sulfonate (SO₄⁻²), carbonate (CO₃⁻²) or nitrate (NO₃⁻²) salt of any of the following metal ions alone, or in combination. Specific examples include Co²⁺, Co³⁺, Fe²⁺, Fe³⁺, Mg¹⁺, Mg²⁺, Mn¹⁺, Mn²⁺, Mn³⁺, ClMn³⁺, HOMn³⁺, Cu⁺¹, Cu²⁺, Ni¹⁺, Ni²⁺, Pd¹⁺, Pd²⁺, Ru¹⁺, Ru²⁺, Ru⁴⁺, Vn⁴⁺, Zn¹⁺, Zn²⁺, Al³⁺, B, Si(OH)₂²⁺, Al³⁺, HOIn³⁺, HOIn³⁺, Pb²⁺, Ag⁺, Sn²⁺, Sn⁴⁺, Ti³⁺, Ti⁴⁺, VO⁺, Pt²⁺, Ce³⁺, Ce⁴⁺. In a particularly useful refinement, the additive comprises cerium acetate, cerium sulfonate, cerium carbonate, or cerium nitrate.

In a variation, the porphyrin-containing compound the porphyrin-containing compound includes a moiety having the following formula:

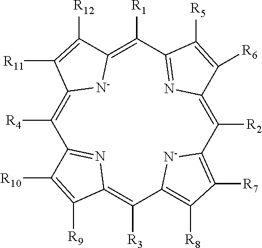

wherein:

R₁, R₂, R₃, R₄, R₅, R₆, R₇, R₈, R₉, R₁₀, R₁₁, R₁₂ are each independently hydrogen, alkyl, or aryl. In a refinement, R₁, R₂, R₃, R₄, are each independently substituted or unsubstituted alkyl or phenyl. In another refinement, R₁, R₂, R₃, R₄, are each phenylmethoxy. In still another refinement, R₅, R₆, R₇, R₈, R₉, R₁₀, R₁₁, R₁₂ are each hydrogen. In this context, substitutions may be with halogens, methoxy, ethoxy, and the like. In addition, in the case of aryl and phenyl, substitutions may also be with alkyl groups.

In still another variation of the present embodiment, the porphyrin-containing compound has the following formula:

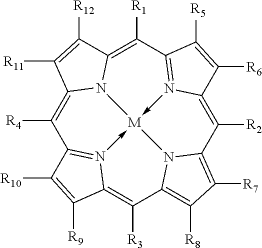

wherein M is a metal or metal-containing moiety. Examples of suitable metals for M or for inclusion, include but are not limit do in the metal containing moiety include Co, Fe, Mg, Mn, Cu, Ni, Pd, Ru, Vn, Zn, Al, B, Si, Al, In, Pb, Ag, Sn, Ti, V, Pt, Ce, and the like. Specific examples for M include Co²⁺, Co³⁺, Fe²⁺, Fe³⁺, Mg¹⁺, Mg²⁺, Mn¹⁺, Mn²⁺, Mn³⁺, ClMn³⁺, HOMn³⁺, Cu⁺¹, Cu²⁺, Ni¹⁺, Ni²⁺, Pd¹⁺, Pd²⁺, Ru¹⁺, Ru²⁺, Ru⁴⁺, Vn⁴⁺, Zn¹⁺, Zn²⁺, Al³⁺, B, Si(OH)₂²⁺, Al³⁺, HOIn³⁺, HOIn³⁺, Pb²⁺, Ag⁺, Sn²⁺, Sn⁴⁺, Ti³⁺, Ti⁴⁺, VO⁺, Pt²⁺, Ce³⁺, Ce⁴⁺.

As set forth above, the composite membrane includes a first polymer that includes a cyclobutyl moiety. In a variation, the first polymer includes a sulfonated-perfluorocyclobutane polymer. The first polymer is applied within the first polymer-containing solution. Ideally, the void volume 36 is completely filled with ionomer after drying.

As set forth above, the composite membrane includes a second polymer that is different than the first polymer. In a variation, the second polymer comprises a non-ionic polymer. Examples of such non-ionic polymers include, but are not limited to, fluoropolymers. In one refinement, the second polymer also includes a perfluorocyclobutyl moiety. Other examples of the second polymer include ionic polymers such as, but not limited to, sulfonated-poly(arylene ether ketone), sulfonated-poly(phenylene), poly(perfluoroalkylperfluoroalkylether sulfonic acid), and combinations thereof.

In one variation, the first polymer includes a cyclobutyl moiety. Suitable polymers having cyclobutyl moieties are disclosed in U.S. Pat. Pub. No. 2007/0099054, U.S. patent application Ser. No. 12/197,530 filed Aug. 25, 2008; Ser. No. 12/197,537 filed Aug. 25, 2008; Ser. No. 12/197,545 filed Aug. 25, 2008; and Ser. No. 12/197,704 filed Aug. 25, 2008; the entire disclosures of which are hereby incorporated by reference. In a variation, the first polymer has a polymer segment comprising polymer segment 1:

E₀-P₁-Q₁-P₂ 1

wherein:

Eₒ is a moiety having a protogenic group such as —SO₂X, —PO₃H₂, —COX, and the like;

P₁, P₂ are each independently absent, —O—, —S—, —SO—, —CO—, —SO₂—, —NH—, NR₂—, or —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, perfluoroalkyl ether, alkylether, or C₁₋₂₅ arylene;

X is an —OH, a halogen, an ester, or

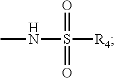

R₄ is trifluoromethyl, O₁₋₂₅ alkyl, O₁₋₂₅ perfluoroalkylene, C₁₋₂₅ aryl, or E₁ (see below); and

Q₁ is a fluorinated cyclobutyl moiety.

In a variation of the present invention, the first polymer comprises polymer segments 2 and 3:

[E₁(Z₁)_{d}]—P₁-Q₁-P₂ 2

E₂-P₃-Q₂-P₄ 3

wherein:

Z₁ is a protogenic group such as —SO₂X, —PO₃H₂, —COX, and the like;

E₁ is an aromatic containing moiety;

E₂ is an unsulfonated aromatic-containing and/or aliphatic-containing moiety;

X is an —OH, a halogen, an ester, or

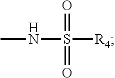

d is the number of Z₁ attached to E₁;

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁, Q₂ are each independently a fluorinated cyclobutyl moiety.

In one refinement, d is equal to the number of aromatic rings in E₁. In another refinement, each aromatic ring in E₁ can have 0, 1, 2, 3, or 4 Z₁ groups.

In another variation of the present embodiment, the first polymer comprises segments 4 and 5:

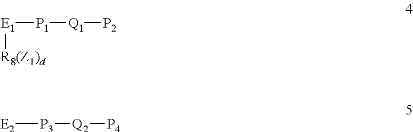

wherein:

Z₁ is a protogenic group such as —SO₂X, —PO₃H₂, —COX, and the like;

E₁, E₂ are each independently an aromatic-containing and/or aliphatic-containing moiety;

X is an —OH, a halogen, an ester, or

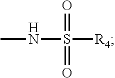

d is the number of Z₁ attached to R₈;

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group;

R₈(Z₁)_{d} is a moiety having d number of protogenic groups; and

Q₁, Q₂ are each independently a fluorinated cyclobutyl moiety.

In a refinement of this variation, R₈ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average.

In another variation of the present embodiment, the first polymer comprises segments 6 and 7:

E₁(Z₁)_{d}—P₁-Q₁-P₂ 6

E₂-P₃-Q₂-P₄ 7

connected by a linking group L₁ to form polymer units 8 and 9:

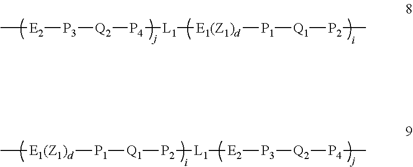

wherein:

Z₁ is a protogenic group such as —SO₂X, —PO₃H₂, —COX, and the like;

E₁ is an aromatic-containing moiety;

E₂ is an unsulfonated aromatic-containing and/or aliphatic-containing moiety;

L₁ is a linking group;

X is an —OH, a halogen, an ester, or

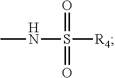

d is a number of Z₁ functional groups attached to E₁;

P₁, P₂, P₃, P₄ are each independently absent, —O—, —S—, —SO—, —SO₂—, —CO—, —NH—, NR₂—, —R₃—, and

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group;

Q₁, Q₂ are each independently a fluorinated cyclobutyl moiety;

i is a number representing the repetition of polymer segment 6 with i typically being from 1 to 200; and

j is a number representing the repetition of a polymer segment 7 with j typically being from 1 to 200. In one refinement, d is equal to the number of aromatic rings in E₁. In another refinement, each aromatic ring in E₁ can have 0, 1, 2, 3, or 4 Z₁ groups.

In still another variation of the present embodiment, the first polymer comprises polymer segments 10 and 11:

E₁(Z₁)_{d}—P₁-Q₁-P₂ 10

E₂(Z₁)_{f}—P₃ 11

wherein:

Z₁ is a protogenic group such as —SO₂X, —PO₃H₂, —COX, and the like;

E₁, E₂ are each independently an aromatic or aliphatic-containing moiety wherein at least one of E₁ and E₂ includes an aromatic containing moiety substituted with Z₁;

X is an —OH, a halogen, an ester, or

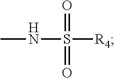

d is the number of Z₁ functional groups attached to E₁;

f is the number of Z₁ functional groups attached to E₂;

P₁, P₂, P₃ are each independently absent, —O—, —S—, —SO—, —SO₂—, —CO—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkyl ether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety, with the proviso that when d is greater than zero, f is zero and when f is greater than zero, d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average. In a variation, polymer segments 10 and 11 are each independently repeated 1 to 10,000 times to form respective polymer blocks that may be joined with a linking group L₁ shown below.

Example for Q₁ and Q₂ in the above formulae are:

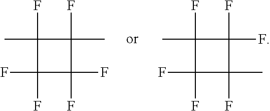

In each of the formulae 2-11, E₁ and E₂ include one or more aromatic rings. For example, E₁ and E₂, include one or more of the following moieties:

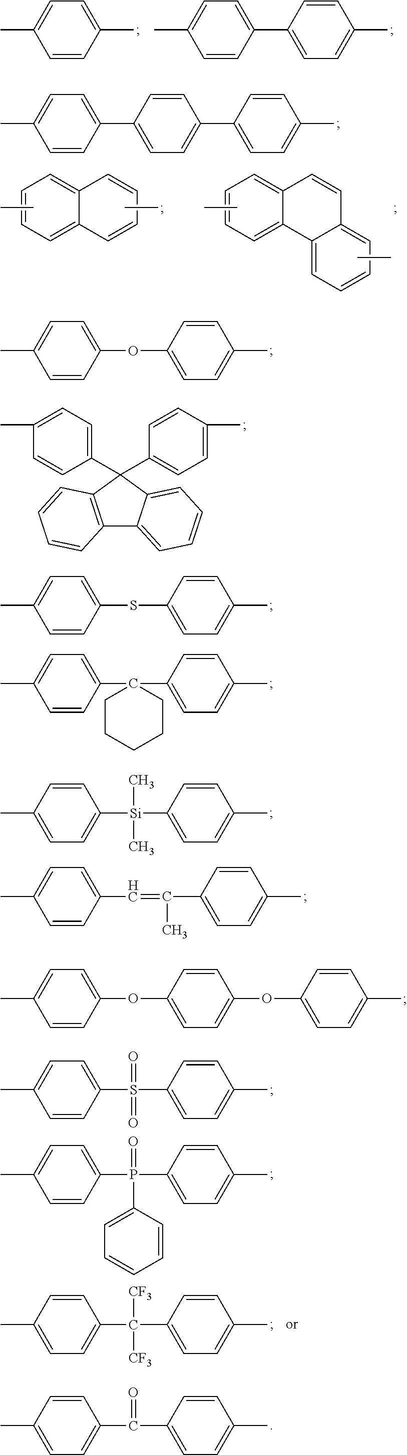

Examples of L₁ include the following linking groups:

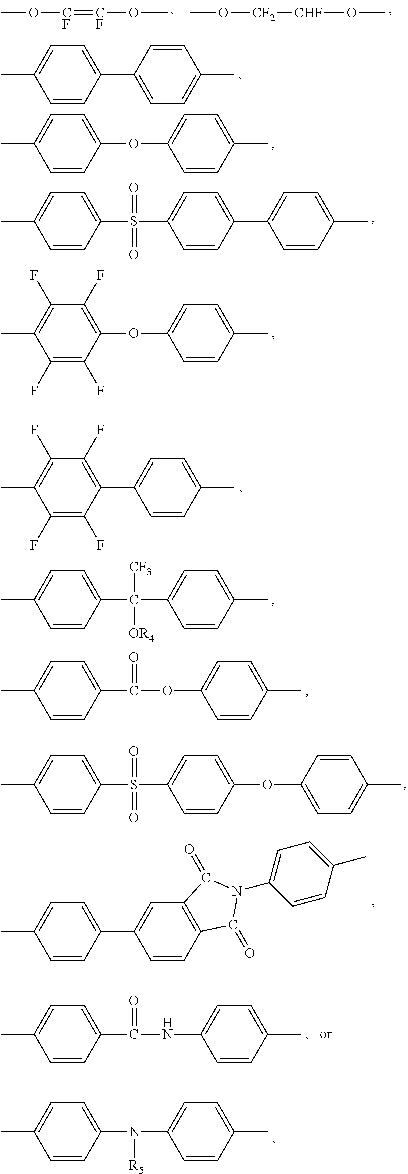

where R₅ is an organic group, such as an alkyl or acyl group.

In another embodiment, the first polymer is a perfluorosulfonic acid polymer (PFSA). In a refinement, such PFSAs are copolymers containing polymerization units based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

In another embodiment, a composite membrane for use in an electrochemical cell is provided. The composite membrane of this embodiment includes a support structure having a predetermined void volume; and a polymeric composition contacting the support structure. The polymeric electrolyte composition comprises an alcoholic solution of the first polymer-containing solution as set forth above. At least 50 percent of the void volume includes a portion of the polymeric electrolyte composition.

In another embodiment of the present invention, a method of forming the composite membrane set forth above is provided. The method of this embodiment comprises a step in which a support structure is contacted with a first polymer-containing solution. The support structure is formed from a polymer and has a predetermined porosity such that the first polymer-containing solution penetrates into interior regions of the support structure defined by the predetermined porosity. The first polymer-containing solution coats at least a portion of the interior regions to form a first coated support structure. The first coated support structure is coated with a second polymer-containing solution that penetrates into interior regions of the first polymer-coated support structure to form a second coated support structure. Penetration of the second polymer-containing solution is enhanced by the first polymer-containing solution as compared to a support structure that is not coated by the first polymer-containing solution. Finally, a solvent composition is removed from the second coated support structure to form the composite membrane. In one refinement, the solvent composition comprises a polar solvent. In another refinement, the solvent composition comprises a component selected from the group consisting of alcohol (e.g., methanol, ethanol, propanol, etc), N,N-dimethylacetamide, and combinations thereof.

In another embodiment, a composite membrane for use in an electrochemical cell is provided. The composite membrane comprises a support structure having a predetermined void volume and a polymeric composition contacting the support structure. The polymeric electrolyte composition comprises a first alcohol containing solution of perfluorosulfonic acid polymer and a second polymer selected from the group consisting of sulfonated poly(arylene ether ketone), sulfonated poly(phenylene), poly(perfluoroalkyl-perfluoroalkylether sulfonic acid), sulfonated perfluorocyclobutane containing polymer, and combinations thereof.

In another embodiment of the present invention, a method of forming the composite membrane set forth above is provided. The method of this embodiment comprises a step in which a support structure is contacted with a polymer-containing solution. The support structure is formed from a polymer and has a predetermined porosity such that the first polymer-containing solution penetrates into interior regions of the support structure defined by the predetermined porosity. The first polymer-containing solution coats at least a portion of the interior regions to form a coated support structure. Finally, solvent is removed from the coated support structure to form the composite membrane. In one refinement, the solvent composition comprises a polar solvent. In another refinement, the solvent composition comprises a component selected from the group consisting of alcohol (e.g., methanol, ethanol, propanol, etc), N,N-dimethylacetamide, and combinations thereof.

The following examples illustrate the various embodiments of the present invention. Those skilled in the art will recognize many variations that are within the spirit of the present invention and scope of the claims.

Cerium (III) containing Expanded Polytetrafluoroethylene Support Structure. A Nafion® 1000 dispersion (1 gram, ˜20 wt % solids DuPont) is diluted with 332 g of iso-propanol to yield an approximate 1.5 weight percent Nafion® solution. This solution is treated with 4.6 g of cerium (III) carbonate and stirred until no observable CO₂ bubbles are evolved. A 75-micron wet layer of the 1.5 weight percent dispersion is coated onto a flat polyethylene sheet. A piece of evenly stretched ePTFE support (example, Donaldson 1326) is then lowered evenly and allowed to contact the wet film. The ePTFE support structure is imbibed with the cerium containing solution and dries under ambient conditions to give an opaque porous ePTFE support layer. A 10-wt. % solids solution of the Nafion® 1000 in alcohol is then coated on top of a flat PTFE sheet using a Bird applicator bar with a 200-micrometer coating gap. The cerium treated porous ePTFE support is lowered evenly and allowed to contact the wet film and immediately become transparent. The wet-film is heated at 80° C. on a heated platen for 30 minutes and a 5-wt. % solids solution of the Nafion® 1000 in alcohol is then coated on top of the ePTFE support using a Bird applicator bar with a 200-micrometer coating gap. The wet-film is heated at 80° C. on a heated platen for 30 minutes and is annealed at 130° C. for four hours. The resultant supported membrane is used as a polyelectrolyte membrane in a humidified, hydrogen-air fuel cell that is operated at less than 100° C.
Manganese (II) Containing Expanded Polytetrafluoroethylene Support Structure. A Nafion® 1000 dispersion (1 gram, ˜20 wt % solids DuPont) is diluted with 332 g of iso-propanol to yield an approximate 1.5 weight percent Nafion® solution. This solution is treated with 1.1 g of manganese (II) carbonate and stirred until no observable CO₂ bubbles are evolved. A 75-micron wet layer of the 1.5 weight percent dispersion is coated onto a flat polyethylene sheet. A piece of evenly stretched ePTFE support (example, Donaldson 1326) is then lowered evenly and allowed to contact the wet film. The ePTFE support structure is imbibed with the cerium containing solution and dries under ambient conditions to give an opaque porous ePTFE support layer. A 10-wt. % solids solution of the Nafion® 1000 in alcohol is then coated on top of a flat PTFE sheet using a Bird applicator bar with a 200-micrometer coating gap. The cerium treated porous ePTFE support is lowered evenly and allowed to contact the wet film and immediately becomes transparent. The wet-film is heated at 80° C. on a heated platen for 30 minutes and a 5-wt. % solids solution of the Nafion® 1000 in alcohol is then coated on top of the ePTFE support using a Bird applicator bar with a 200-micrometer coating gap. The wet-film is heated at 80° C. on a heated platen for 30 minutes and is annealed at 130° C. for four hours. The resultant supported membrane is used as a polyelectrolyte membrane in a humidified, hydrogen-air fuel cell that is operated at less than 100° C.
Cobalt(II) tetramethoxyphenylporphyrin containing Expanded Polytetrafluoroethylene Support Structure. A Nafion® 1000 dispersion (1 gram, ˜20 wt % solids DuPont) is diluted with 332 g of iso-propanol to yield an approximate 1.5 weight percent Nafion® solution. In the solution, 7.9 g of cobalt(II) tetramethoxyphenylporphyrin is dissolved. A 75-micron wet layer of the 1.5 weight percent dispersion is coated onto a flat polyethylene sheet. A piece of evenly stretched ePTFE support (example, Donaldson 1326) is then lowered evenly and allowed to contact the wet film. The ePTFE support structure is imbibed with the cerium containing solution and dries under ambient conditions to give an opaque porous ePTFE support layer. A 10-wt. % solids solution of the Nafion® 1000 in alcohol is then coated on top of a flat PTFE sheet using a Bird applicator bar with a 200-micrometer coating gap. The cerium treated porous ePTFE support is lowered evenly and allowed to contact the wet film and immediately becomes transparent. The wet-film is heated at 80° C. on a heated platen for 30 minutes and a 5-wt. % solids solution of the Nafion® 1000 in alcohol is then coated on top of the ePTFE support using a Bird applicator bar with a 200-micrometer coating gap. The wet-film is heated at 80° C. on a heated platen for 30 minutes and is annealed at 130° C. for four hours. The resultant supported membrane is used as a polyelectrolyte membrane in a humidified, hydrogen-air fuel cell that is operated at less than 100° C.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for forming a composite membrane for fuel cell applications, the method comprising:
a) contacting a support structure with a first polymer-containing solution, the first polymer-containing solution includes a first polymer and an additive that inhibits polymeric degradation, and a porphyrin-containing compound, the support having a predetermined porosity such that the first polymer-containing solution penetrates into interior regions of the support structure defined by the predetermined porosity wherein the first polymer-containing solution coats at least a portion of the interior regions to form a first coated support structure having the additive therein;
b) contacting the first coated support structure with a second polymer-containing solution that penetrates into interior regions of the first coated support structure to form a second coated support structure wherein penetration of the second polymer-containing solution is enhanced by the first polymer-containing solution as compared to a support structure that is not coated by the first polymer-containing solution; and
c) removing solvent from the second coated support structure to form the composite membrane.

2. The method of claim 1 wherein the additive comprises a component selected from the group consisting of cerium-containing compounds, manganese-containing compounds, and a porphyrin-containing compound.

3. The method of claim 1 wherein the additive comprises a soluble sulfonate (SO₄⁻²), carbonate (CO₃⁻²) or nitrate (NO₃⁻²) salt of a metal ion selected from the group consisting of Co²⁺, Co³⁺, Fe²⁺, Fe³⁺, Mg¹⁺, Mg²⁺, Mn¹⁺, Mn²⁺, Mn³⁺, ClMn³⁺, HOMn³⁺, Cu⁺¹, Cu²⁺, Ni¹⁺, Ni²⁺, Pd¹⁺, Pd²⁺, Ru¹⁺, Ru²⁺, Ru⁴⁺, Vn⁴⁺, Zn¹⁺, Zn²⁺, Al³⁺, B, Si(OH)₂²⁺, Al³⁺, HOIn³⁺, HOIn³⁺, Pb²⁺, Ag⁺, Sn²⁺, Sn⁴⁺, Ti³⁺, Ti⁴⁺, VO⁺, Pt²⁺, Ce³⁺, and Ce⁴⁺.

4. The method of claim 1 wherein the first polymer-containing solution comprises a solvent selected from the group consisting of water, alcohols, and combinations thereof.

5. The method of claim 1 wherein the support structure comprises an expanded polytetrafluoroethylene.

6. The method of claim 1 wherein the first polymer is a polymer having a cyclobutyl moiety and a plurality of protogenic groups.

7. The method of claim 1 wherein the first polymer is described by formula 1:
E₀-P₁-Q₁-P₂ 1
wherein:
Eₒ is a moiety having a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 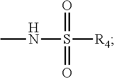
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

8. The method of claim 1 wherein the first polymer is poly[block-(sulfonated-polyperfluorocyclobutane-biphenyl ether)-co-block-(polyperfluorocyclobutane-hexafluoroisopropylidene-bisphenol)].

9. The method of claim 1 wherein the first polymer is a PFSA polymer.

10. The method of claim 1 wherein the first polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

11. A method for forming a composite membrane for fuel cell applications, the method comprising:
a) contacting a support structure with a first polymer-containing solution, the first polymer-containing solution includes a first polymer and an additive that inhibits polymeric degradation, the support having a predetermined porosity such that the first polymer-containing solution penetrates into interior regions of the support structure defined by the predetermined porosity wherein the first polymer-containing solution coats at least a portion of the interior region to form a first coated support structure having the additive therein;
b) removing solvent from the first coated support structure to form the composite membrane.

12. The method of claim 11 wherein the additive comprises a component selected from the group consisting of cerium-containing compounds, manganese-containing compounds, and a porphyrin-containing compound.

13. The method of claim 11 wherein the additive comprises a soluble sulfonate (SO₄⁻²), carbonate (CO₃⁻²) or nitrate (NO₃⁻²) salt of a metal ion selected from the group consisting of Co²⁺, Co³⁺, Fe²⁺, Fe³⁺, Mg¹⁺, Mg²⁺, Mn¹⁺, Mn²⁺, Mn³⁺, ClMn³⁺, HOMn³⁺, Cu⁺¹, Cu²⁺, Ni¹⁺, Ni²⁺, Pd¹⁺, Pd²⁺, Ru¹⁺, Ru²⁺, Ru⁴⁺, Vn⁴⁺, Zn¹⁺, Zn²⁺, Al³⁺, B, Si(OH)₂²⁺, Al³⁺, HOIn³⁺, HOIn³⁺, Pb²⁺, Ag⁺, Sn²⁺, Sn⁴⁺, Ti³⁺, Ti⁴⁺, VO⁺, Pt²⁺, Ce³⁺, and Ce⁴⁺.

14. The method of claim 11 wherein the first polymer-containing solution comprises a solvent selected from the group consisting of water, alcohols, and combinations thereof.

15. The method of claim 11 wherein the support structure comprises an expanded polytetrafluoroethylene.

16. The method of claim 11 wherein the first polymer is described by formula 1:
E₀-P₁-Q₁-P₂ 1
wherein:
Eₒ is a moiety having a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 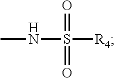
R₄ is trifluoromethyl, O₁₋₂₅ alkyl, C₁₋₂₅ perfluoroalkylene, C₁₋₂₅ aryl, or E₁ (see below); and
Q₁ is a fluorinated cyclobutyl moiety.

17. The method of claim 11 wherein the first polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

18. A composite membrane for use in an electrochemical cell, the composite membrane comprising:
a support structure having a predetermined void volume;
a polymeric composition contacting the support structure, the polymeric electrolyte composition comprising:
a first polymer; and
an additive that inhibits polymeric degradation.

19. The composite support of claim 18 wherein the polymeric electrolyte composition further comprises a second polymer, the second polymer being a non-ionic polymer.

20. The composite membrane of claim 18 wherein the cerium containing compound is cerium acetate, cerium sulfonate, cerium carbonate or cerium nitrate.

21. The composite membrane of claim 18 wherein the first polymer is described by formula 1:
E₀-P₁-Q₁-P₂ 1
wherein:
Eₒ is a moiety having a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 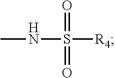
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

22. The composite membrane of claim 18 wherein the first polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.
